(19) United States
(12) Patent Application Publication
(10) Pub. No.: US 2004/0207324 A1
(43) Pub. Date: Oct. 21, 2004

(54) Plasma display

(76) Inventor: Morio Fujitani, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/485,215

(22) PCT Filed: Apr. 17, 2003
(86) PCT No.: PCT/JP03/04899

(30) Foreign Application Priority Data
Apr. 18, 2002 (JP) 2002-115855
Apr. 18, 2002 (JP) 2002-115856
Apr. 18, 2002 (JP) 2002-115857
Apr. 18, 2002 (JP) 2002-115858

(51) Int. Cl. H01J 17/49

(52) U.S. Cl. 313/582

(57) ABSTRACT

A plasma display device comprises display electrodes (26) that are opposingly formed for each display line A on a front substrate with an discharge gap interposed, a dielectric layer formed in a manner covering display electrodes (26), and a phosphor layer that emits light due to discharge between display electrodes (26). At least one recess (27a) is formed on the surface of each of discharge cells on the side of the discharge space of the dielectric layer, and discharge electrodes (25a) that constitute the display electrodes are formed in a manner projecting out toward discharge gap (24) so that they face each other with the discharge gap (24) interposed in the bottom region of recess (27a).

### TECHNICAL FIELD

The present invention relates to plasma display devices known as display devices.

### BACKGROUND ART

In recent years, there has been an increasing expectation on large-shield wall-hung television for use as bidirectional information terminals. As display devices for this purpose, many types of displays are available such as liquid crystal display panel, field emission display and electroluminescent display. Among them, plasma display panel (hereinafter referred to as PDP) is drawing attention as a flat display device with good visibility because of self-luminescence, ability to display beautiful pictures, and ease of realizing larger shield sizes, and efforts are being made to achieve higher definition and larger shield sizes.

The driving schemes of PDP can be broadly divided into AC type and DC type. Thebacke two types of discharge schemes, namely, surface discharge type and opposing discharge type. Currently, AC type and surface discharge type PDP's are dominant from the standpoints of achieving higher definition and larger shield, and simplicity of manufacturing.

FIG. 20 shows an example of a conventional PDP panel structure. As illustrated in FIG. 20, the PDP is comprised of front panel 1 and back panel 2.

Front panel 1 is comprised of transparent front substrate 3, a plurarity of display electrodes 6, dielectric layer 7, and protective film 8. Front substrate 3 is a glass substrate such as made from boron silicide sodium glass fabricated by the floating method. Display electrodes 6 consist of a pair of scan electrode 4 and sustain electrode 5, and a plurarity of pairs are laid out on front substrate 3 in a striped manner. Dielectric layer 7 is formed in a manner covering a group of display electrodes 6, and protective film 8 made from MgO is formed on dielectric layer 7.

Here, scan electrode 4 and sustain electrode 5 consist of transparent electrodes 4a, 5a that serve as discharge electrodes and bus electrodes 4b, 5b that are electrically connected with transparent electrodes 4a, 5a, respectively. Bus electrodes 4b, 5b are formed with such material as Cr/Cu/Cr, Ag or the like.

Back panel 2 consists of back substrate 9, address electrodes 10, dielectric layer 11, a plurarity of stripe-shaped barrier ribs 12, and phosphor layers 13. Address electrodes 10 are formed on back substrate 9 that is disposed opposite front substrate 3 in the direction orthogonal to display electrodes 6. Dielectric layer 11 is formed in a manner covering address electrodes 10. Each ribs 12 are formed on dielectric layer 11 between address electrodes 10 and in parallel to address electrodes 10. Phosphor layer 13 is formed on the sides between ribs 12 and on the surface of dielectric layer 11. Here, for the purpose of displaying colors, phosphor layer 13 normally consists of three sequentially disposed colors of red, green, and blue.

front and back panels 1, 2 are opposed to each other across a minute discharge space with display electrodes 6 orthogonal to address electrodes 10, and their periphery is sealed with a sealing member. The discharge space is filled with discharge gas, which is made by mixing for example, neon (Ne) and xenon (Xe), at a pressure of about 66,500 Pa (500 Torr). In this way, the PDP is formed.

The discharge space of this PDP is partitioned into a plurality of sections by barrier ribs 12, and a plurality of discharge cells or light-emitting pixel regions is each defined by barrier ribs 12 and display and address electrodes 6, 10 that are orthogonal to each other.

With this PDP, discharge is caused by periodic application of voltage to-address electrode 10 and display electrode 6, and ultraviolet rays generated by this discharge are applied to phosphor layer 13, thereby being converted into visible light. In this way, an image is displayed.

As shown in FIG. 14, scan and sustain electrodes 4, 5 of display electrode 6 are disposed with discharging gap 14 between these electrodes 4, 5. Light-emitting pixel region 15 is a region surrounded by this display electrode 6 and barrier ribs 12, and non-light-emitting pixel region 16 is an adjoining gap or region between adjacent display electrodes 6. Also, a black stripe is sometimes formed in non-light-emitting pixel region 16 for the purpose of improving the contrast.

For the development of PDP, further effort toward higher luminance, higher efficiency, lower power consumption, and lower cost are essential. In order to achieve a higher efficiency, it is essential to control discharge in each region of light-emitting pixel. Especially in the area of spread of discharge perpendicular to display electrodes 6, as bus electrodes 4b, 5b shield the light emitted by the phosphor, it is effective to control discharge from spreading to the shielded area.

As an approach to efficiency improvement, a method is known, as disclosed in Japanese Patent Laid-Open Application No. H8-250029, for example, in which the discharge in the area shielded by bus electrodes 4b, 5b is suppressed by increasing the thickness of dielectric layer 7 on bus electrodes 4b, 5b.

However, in the conventional structure as described above, although the discharge in the direction perpendicular to the display electrodes is suppressed, the discharge in the direction parallel to the display electrodes is not suppressed and spreads to the neighborhood of barrier ribs. In this case, there is a possibility of lowering of the electron temperature due to ribs and reduction in the efficiency due to occurrence of recombination of electrons and ions.

### DISCLOSURE OF THE INVENTION

The plasma display device of the present invention includes a pair of front substrate and a back substrate that are opposingly disposed in a manner such that discharge spaces partitioned by ribs are formed between the substrates, a pair of display electrodes comprising discharge electrodes that are opposingly disposed on the front substrate for each display line with discharge gaps interposed in a manner such that discharge cells are formed between the ribs and bus electrodes for supplying power to the discharge electrodes, and a dielectric layer formed in a manner covering the display electrodes, where the dielectric layer has at least one recess formed on the surface on the side of the discharge space of each discharge cell, and the discharge electrodes are formed in a manner projecting out from the bus electrodes toward the discharge gap in a manner opposing to each other in the bottom region of the recess with the discharge gap interposed.

With this structure, luminous efficiency can be improved and driving of the panel can be stabilized.

### BRIEF DESCRIPTION OF THE DRAWINGS

FIG. 1 is a sectional perspective view to illustrate schematic structure of a plasma display device in Preferred Embodiment-1 of the present invention.

FIG. 2 is a perspective view of a section of a front panel of the plasma display device.

FIG. 3 is a plan view for illustrating the positional relationship of key parts of the plasma display device.

FIG. 4 is a plan view for illustrating the positional relationship of key parts of the plasma display device.

FIG. 5 is a plan view for illustrating the positional relationship of key parts of the plasma display device.

FIG. 6 is a schematic cross-sectional view of the structure of the front panel for illustrating discharging state of the plasma display panel.

FIG. 7 is a cross-sectional view of the schematic structure of the front panel for illustrating discharging state of a conventional plasma display panel.

FIG. 8A, FIG. 8B and FIG. 8C are plan views for illustrating positional relationship of key parts of a plasma display device in Preferred Embodiment-1 of the present invention.

FIG. 9A and FIG. 9B are plan views for illustrating positional relationship of key parts of the plasma display device.

FIG. 10A and FIG. 10B are plan views for illustrating positional relationship of key parts of the plasma display device.

FIG. 11 is a perspective view of a part of the front panel of a plasma display device in Preferred Embodiment-2 of the present invention.

FIG. 12 is a plan view for illustrating positional relationship of key parts of the plasma display device.

FIG. 13 is a schematic cross-sectional view of the structure of the front panel for illustrating discharging state of the plasma display device.

FIG. 14 is a plan view for illustrating positional relationship of key parts of the plasma display device.

FIG. 15 is a plan view for illustrating positional relationship of key parts of the plasma display device.

FIG. 16A and FIG. 16B are plan views for illustrating positional relationship of key parts of the plasma display device.

FIG. 17A, FIG. 17B and FIG. 17C are plan views for illustrating positional relationship of key parts of the plasma display device.

FIG. 18A, FIG. 18B are plan views for illustrating positional relationship of key parts of the plasma display device.

FIG. 19A, FIG. 19B and FIG. 19C are partial perspective views for illustrating the configurations of the recess of the plasma display panel.

FIG. 20 is a schematic sectional perspective view of the structure of a conventional plasma display device.

FIG. 21 is a plan view for illustrating positional relationship of key parts of the plasma display device.

### DETAILED DESCRIPTION OF THE PREFERRED EMBODIMENTS

Referring to drawings, a description of the plasma display devices in preferred embodiments of the present invention will now be given below. In the drawings, similar structural components have the same reference numerals.

Preferred Embodiment-1:

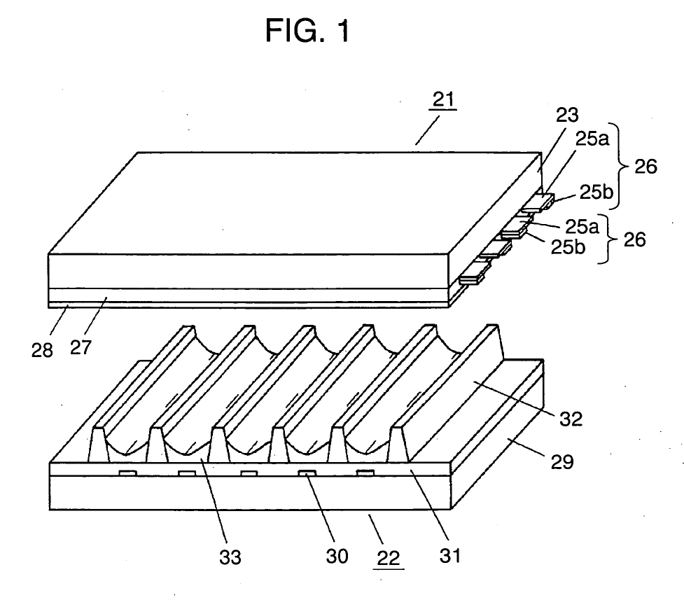

FIG. 1 is a sectional perspective view of an example of panel structure of a plasma display panel as used in the plasma display device in Preferred Embodiment-1 of the present invention.

As illustrated in FIG. 1, the PDP consists of front panel 21 and back panel 22.

Front panel 21 consists of transparent front substrate 23, a plurarity of display electrodes 26, dielectric layer 27, and protective film 28. Front substrate 23 is a glass substrate made of boron silicate sodium glass prepared by a float prpcess, for example. A plurarity of display electrodes 26 are formed on front substrate 23 and consist of discharge electrodes 25a that are opposingly formed with discharge gap interposed and bus electrode 25b which is electrically connected to discharge electrode 25a for supplying power. Dielectric layer 27 is formed in a manner covering display electrodes 26, and protective film 28 made of magnesium oxide (MgO) is formed on dielectric layer 27. A plurarity of display electrodes 26 are formed as pairs of a scan electrode and a sustain electrode.

Back panel 22 consists of back substrate 29, address electrodes 30, dielectric layer 31, a pluraruty of striped ribs 32, and phosphor layers 33.

Address electrodes 30 are formed on back substrate 29 that is disposed facing front substrate 23. Dielectric layer 31 is formed in a manner covering address electrodes 30. A plurarity of striped ribs 32 are formed on dielectric layer 31 in between address electrodes 30 in parallel to them. Phosphor layers 33 are formed on the sides of ribs 32 and on the surface of dielectric layer 31. Incidentally, for the purpose of displaying colors, phosphor layers 33 normally consist of sequentially disposed red, green, and green phosphors.

Front panel 21 and back panel 22 are opposingly disposed with a minute discharge space interposed in a manner such that display electrodes 26 and address electrodes 30 intersect at right angles, and the periphery is sealed with a sealing member. An discharge gas prepared by mixing xenon (Xe) and neon (Ne) or helium (He) is filled in at a pressure of about 66,500 Pa (500 Torr).

This discharge space is divided by rib 32 into a plurarity of sections and an discharge cell, being a unitary light-emmitting region, is formed at the place where display electrodes 26 and address electrodes 30 intersect at right angles.

Also, black stripes may be formed between discharge cells for the purpose of improving contrast.

With this PDP, discharge is caused by periodic application of voltage to address electrodes 30 and display electrodes 26, and ultraviolet rays generated by this discharge are applied to phosphor layer 13, thereby being converted into visible light. In this way, an image is displayed.

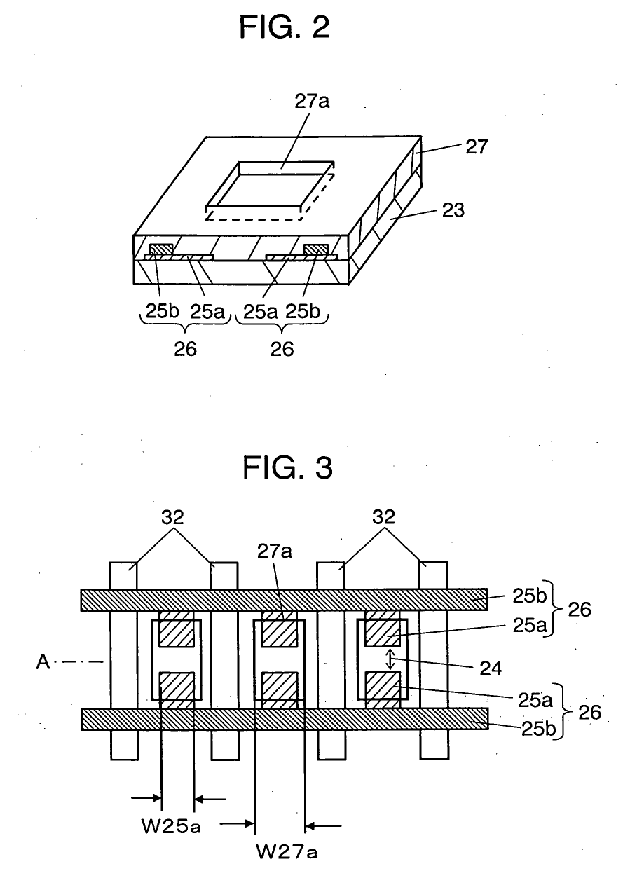

FIG. 2 is a sectional perspective view of the front panel of a plasma display device in Preferred Embodiment-1 of the present invention. In FIG. 2, recess 27a is formed for each discharge cell on the surface on the side of the discharge space of dielectric layer 27 that is formed on front substrate 23 in a manner covering display electrodes 26.

FIG. 3 illustrates the positional relationship among recess 27a, display electrodes 26, and ribs 32. As shown in FIG. 3, recess 27a is formed between ribs 32.

Display electrodes 26 consist of discharge electrode 25a made of a transparent electrode and bus electrode 25b for supplying power to discharge electrode 25a. Discharge electrodes 25a in a discharge cell are formed in a manner projecting out in the direction orthogonal to bus electrodes 25b so that they face each other with discharge gap 24 interposed in each display line A. That is, discharge electrodes 25a in a discharge cell are situated in the bottom region of recess 27a. The width, W25a, of that part of discharge electrodes 25a in a discharge cell which face each other with discharge gap 24 interposed is made equal to or less than the width, W27a, of recess 27a. In the example illustrated in FIG. 3, the width, W25a, of that parts of discharge electrodes 25a which face each other with discharge gap 24 interposed in an discharge cell is less than the width, W27a, of recess 27a.

Here, in order to achieve a higher efficiency of the PDP, it is essential to control discharge in each region of light-emitting pixel. Especially in the region in which discharge in the direction perpendicular to display electrodes 26 spreads, as bus electrodes 25b shield the light from phosphor 33 thus making it useless, it is effective to control the discharge from spreading to the region to be shielded.

It is also effective for efficiency improvement to control not only the discharge in the direction perpendicular to display electrodes 26 but also the discharge in the parallel direction. This is because, when the discharge spreads in the direction parallel to display electrodes 26 up to the neighborhood of ribs 32, electron temperature decreases near ribs 32 thus presenting a possibility of a reduction in the efficiency.

Furthermore, when discharge takes place near ribs 32, ribs 32 are negatively charged and positive ions are attracted to ribs 32. As a result, ribs 32 are etched by occurrence of recombination of electrons and ions and by ion bombardment of ribs 32. There is a possibility that a portion of ribs 32 that are etched precipitates on phosphor 33 thus deteriorating the characteristic.

However, in this preferred embodiment, recess 27a is formed for each individual discharge cell and recess 27a is located between adjacent ribs 32, or the width of recess 27a is smaller than the distance between adjacent ribs 32. By forming recess 27a in this manner, discharge can be retained only in the bottom region of recess 27a. That is, the discharge can be deterred from spreading in the direction perpendicular to display electrodes 26 up to bus electrodes 25b where the light from phosphor 33 is shielded or spreading in the direction parallel to display electrodes 26 to the neighborhood of ribs 32. Furthermore, as MgO is applied on the sides of recess 27a, too, there is no possibility of the sides of recess 27a being etched. Still more, as discharge electrodes 25a in a discharge cell are situated in the bottom region of recess 27a and are formed in a manner projecting out in the direction orthogonal to bus electrodes 25b so that they face each other with discharge gap 24 interposed, discharge electrodes 25a in an discharge cell are at a distance from ribs 32. As a result, the accumulation of electric charges in the neighborhood of ribs 32 is suppressed, and the advantage of suppressing discharge in the neighborhood of ribs 32 is further enhanced.

Here, when discharge electrodes 25a are formed with transparent electrodes, the light emission from phosphor 33 can be efficiently taken out.

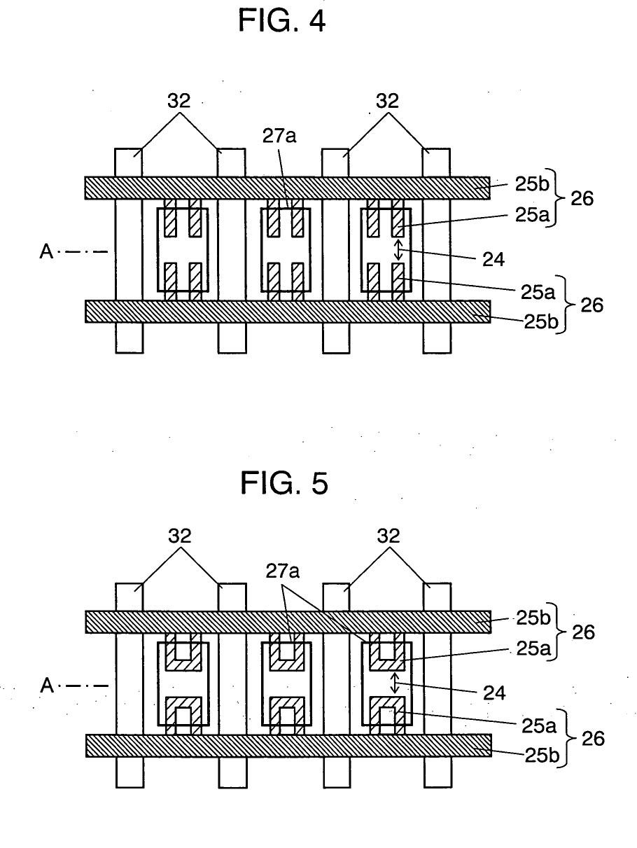

On the contrary, when discharge electrodes 25a are formed with opaque metal electrodes similar to bus electrodes 25b, a cost reduction can be-achieved. In this case, however, the light emission from phosphor 33 is shielded by discharge electrodes 25a. It is possible, though, to improve the efficiency of taking out the light emission by making the area of discharge electrodes 25a in the discharge cell small without changing the dimension of discharge gap 24. Examples of such structures are illustrated in FIG. 4 and FIG. 5.

Discharge electrodes 25a in a discharge cell as illustrated in FIG. 4 are divided into two or more sections such as rectangles. Discharge electrodes 25a in a discharge cell as illustrated in FIG. 5 have a hollow shape made by removing discharge electrodes 25a shown in FIG. 3. By making the area of discharge electrodes 25a in a discharge cell in this way, the above-mentioned efficiency can be improved while enabling a reduction in electric power consumption. Same thing applies to the case where transparent electrodes are employed as discharge electrodes 25a.

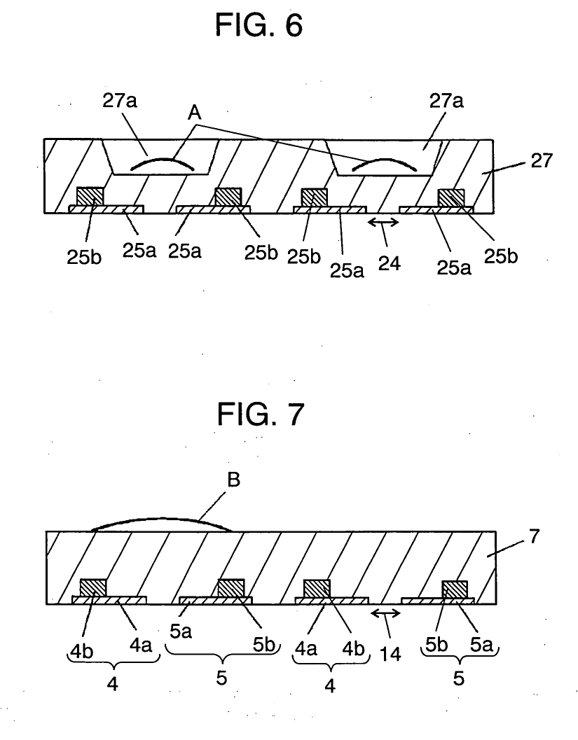

Next, a description on the control of the discharge region will be given in reference to FIG. 6 and FIG. 7. FIG. 6 is a cross-sectional view of a schematic structure of the front panel for illustrating the discharging state of a plasma display device in Preferred Embodiment-1. FIG. 7 is an illustration of the discharging state of a conventional plasma display device.

In the conventional structure of FIG. 7 that does not have recesses, as the thickness of the dielectric layer is uniform, capacitance C is uniform over the surface of dielectric layer 27, and discharge B spreads as shown in FIG. 7. Accordingly, the efficiency decreases for the reason described above.

On the contrary, as shown in FIG. 6, recess 27a is formed for each discharge cell thereby to make the thickness of that part of dielectric layer 27 thin and to increase capacitance C. As a result, charges for discharge are collectively formed in the bottom region of recess 27a. Also, as the thickness of dielectric layer 27 of the part where recess 27a is formed is thinner than other parts, discharge starts to take place in the bottom region of recess 27a.

Conversely speaking, as the thickness of dielectric layer 27a becomes thicker except the bottom region of recess 27a, the capacitance of that part becomes smaller. That is, the electric charges that exist in the thick part are fewer. Furthermore, as the thickness of dielectric layer 27 is thicker, the discharge voltage is higher.

In addition, by projecting out discharge electrodes 25a in a discharge cell in adaptation to the shape of recess 27a and separating them from ribs 32, the electric charges that accumulate in the neighborhood of ribs 32 are also suppressed.

As a result of these advantages, discharge A is restricted to the bottom region of recess 27a and the efficiency is improved. Also, by applying this principle, it is possible to arbitrarily control the amount of electric charges that are formed in recess 27a by changing the size of recess 27a.

Also, it is generally known to increase the partial pressure of xenon (Xe) used as the discharge gas in order to achieve a higher efficiency of a PDP. However, when the partial pressure of xenon (Xe) is increased, not only the problem of increase in discharge voltage occurs, but also the problem of causing easy saturation of luminance occurs due to an increase in ultraviolet rays that are produced. In order to avoid this, a method is known to decrease the capacitance of the dielectric layer by increasing the thickness of the dielectric layer so as to decrease the electric charges that are generated by a single pulse. In this case, however, a problem of efficiency reduction occurs as the transmissivity of the dielectric layer itself decreases with increasing thickness of the dielectric layer. Also, when the thickness is simply increased, a problem of further increase in the discharge voltage occurs.

However, according to the present invention, a discharge gas that is a mixture of xenon (Xe), neon (Ne) and/or helium (He) is filled in the discharge space with the partial pressure of xenon (Xe) set to a range 5 to 30%. And, by controlling the current with the shape of recess 27a, prevention of luminance saturation that would otherwise occur at high xenon (Xe) partial pressure is enabled. Also, by changing the shape or size of recess 27a, the amount of current can be limited to an arbitrary value. Furthermore, in this preferred embodiment, as the current is controlled by dielectric layer 27 only, high xenon (Xe) partial pressure can be used without calling for a change in the circuit or driving method.

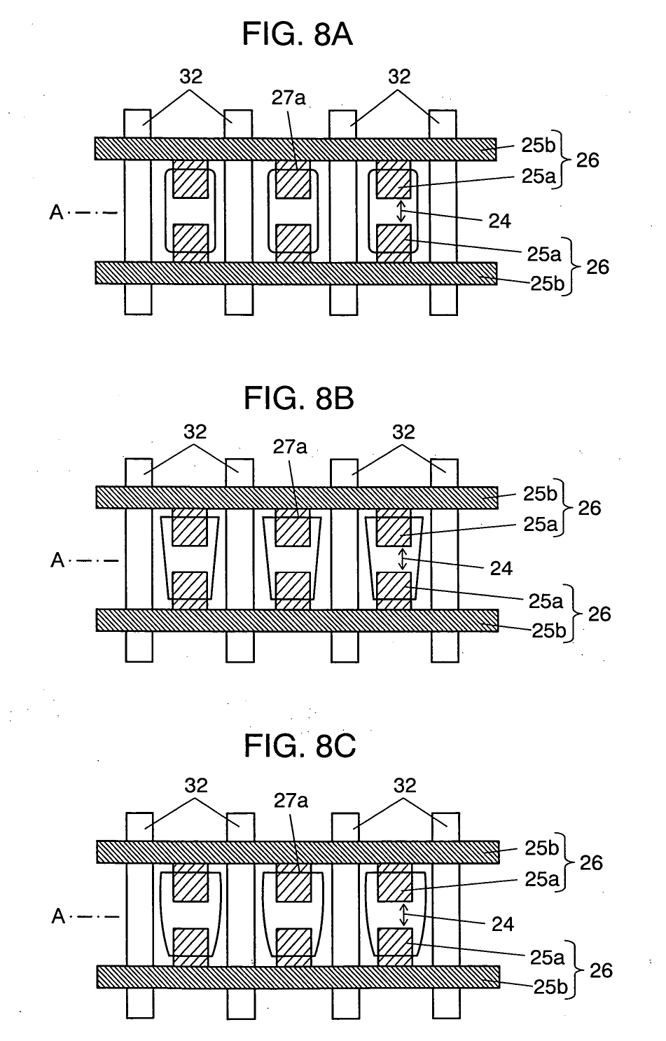

Here, the shape of recess 27a is not limited to rectangles as shown in FIG. 3 and any shape is acceptable in so far as the width, W27a, is greater than the width, W25a, of the part that discharge electrodes 25a face each other with the discharge gap 24 interposed. FIG. 8A to FIG. 8C show examples of other shapes of recess 27a. The shape of recess 27a as shown in FIG. 8A is a rectangle with rounded corners. The shape of recess 27a as shown in FIG. 8B is a trapezoid. The shape of the recess as shown in FIG. 8C is a trapezoid with roundish sides. The shape includes oval or barrel-shaped shapes.

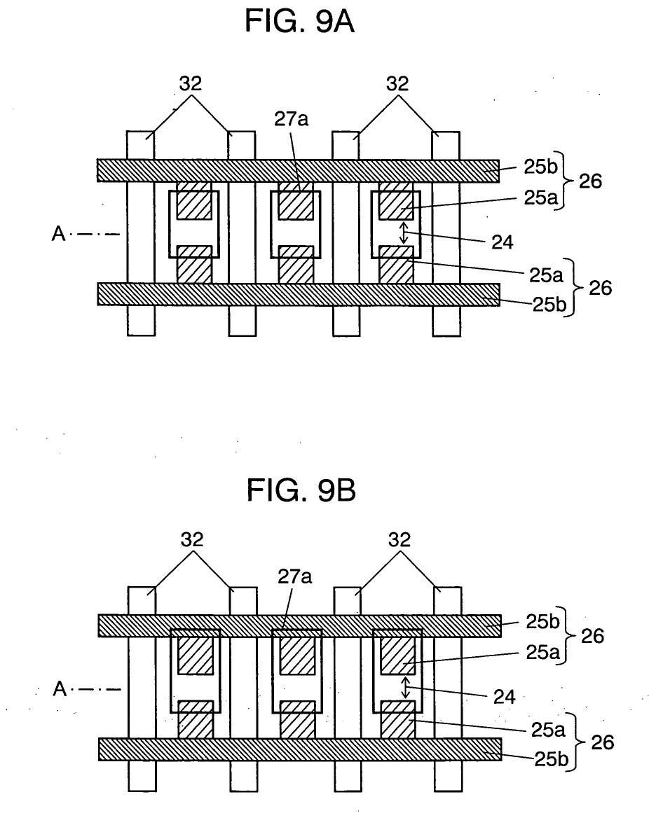

Also, by making the area of recess 27a on the side of the scan electrode, being one of the display electrodes 26, larger, discharge between the scan electrodes and address electrodes 30 is made easy to take place thus making it possible to widen the driving margin of the panel. Examples of such configurations are shown in FIG. 9A and FIG. 9B. FIG. 9A shows an example in which recess 27a is formed closer to the scan electrode relative to discharge gap 24 in order to increase the area in which recess 27a and display electrode 26 that serves as the scan electrode face each other. FIG. 9B shows an example in which recess 27a is formed in a manner such that a part of it is located on bus electrode 25b of the scan electrode in order to enhance the above-mentioned advantage. In these structures, too, the shape of recess 27a may be as shown in FIG. 8A to FIG. 8C.

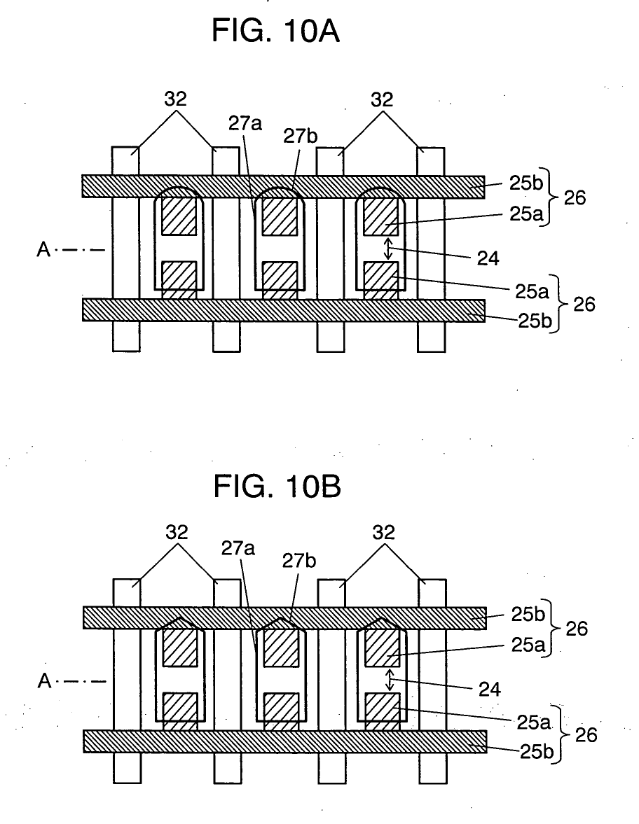

Here, in the structure as shown in FIG. 9B, as the thickness of dielectric layer 27 becomes smaller on the part of bus electrode 25b due to recess 27a, there is a possibility of the dielectric breakdown strength of dielectric layer 27 being reduced on that part. Accordingly, it is preferable to form the part of recess 27a that is located on bus electrode 25b be as small as possible. In order to do this, extended recess 27b made by protruding a part of recess 27a is formed in a manner facing bus electrode 25b. For example, curved extended recess 27b as illustrated in FIG. 10A is formed. Also, pointed extended recess 27b is formed as illustrated in FIG. 10B.

In the above description, the shape of recess 27a can be polygonal, circular, or oval and is not limited to what is described above so far as the above object can be achieved.

Preferred Embodiment-2:

Referring to drawings, a description of a plasma display device in Preferred Embodiment-2 of the present invention will be given. The difference of structure from that of Preferred Embodiment-1 of the present invention lies in the configuration of the recess. In the following, a detailed description of the difference will be given. The same reference numerals are given to those structural elements that are similar to those in Preferred Embodiment-1.

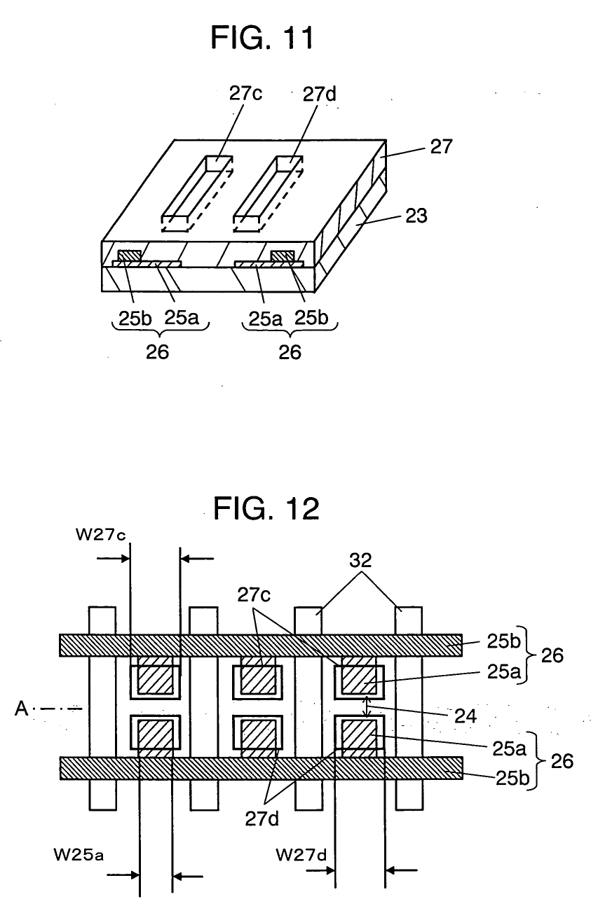

FIG. 11 is a partial perspective view of a front panel of the plasma display panel in Preferred Embodiment-2 of the present invention. In FIG. 11, two recesses 27c and 27d are formed in each discharge cell on the surface of a discharge space of dielectric layer 27 that covers display electrodes 26. Also, FIG. 12 illustrates the positional relationship among recess 27c, recess 27d, display electrodes 26 and ribs 32. As illustrated in FIG. 12, recess 27c and recess 27d are formed in between ribs 32.

Display electrodes 26 are comprised of discharge electrodes 25a consisting of transparent electrodes that are opposingly formed with discharge gap 24 interposed for each display line A and bus electrodes 25b for supplying power to discharge electrodes 25a. Discharge electrodes 25a in a discharge cell are formed in a manner projecting out in the direction orthogonal to bus electrodes 25b so that they face each other with discharge gap 24 interposed. One of discharge electrodes 25a in a discharge cell is situated in the bottom region of recess 27c while the other faces the bottom region of recess 27d. The width, W25a, of discharge electrodes 25a that face each other with discharge gap 24 interposed is made equal to or smaller than the width W27c of recess 27c and width W27d of recess 27d. FIG. 12 illustrates an example in which the width (W25a) of that part of discharge electrodes 25a which oppose each other with discharge gap 24 interposed is made smaller than the width (W27c, W27d) of recesses 27c, 27d.

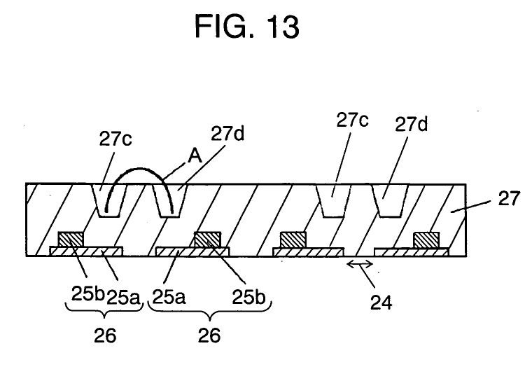

FIG. 13 is an illustration of the advantage of forming two recesses 27c, 27d on dielectric layer 27 in the plasma display panel of Preferred Embodiment-2. In FIG. 13, solid line A represents a discharge.

In FIG. 13, as the thickness of that part of dielectric layer 27 where two recesses 27c, 27d are formed is thin, capacitance C of that part is large. As a result, charges for discharge are collectively formed in the bottom regions of recess 27c and recess 2.7d thereby limiting the discharging region.

Furthermore, in this structure, two recesses 27c and 27d are formed with discharge gap 24 interposed as shown in FIG. 13. Discharge A takes place between the bottom region of recess 27c and the bottom region of recess 27d with discharge gap 24 interposed. As a result, the discharge distance is extended, the probability of exciting the discharge gas is increased, thus providing the compatibility of control of discharge and high efficiency. This effect is more pronounced when the partial pressure of xenon (Xe) in the discharge gas is increased.

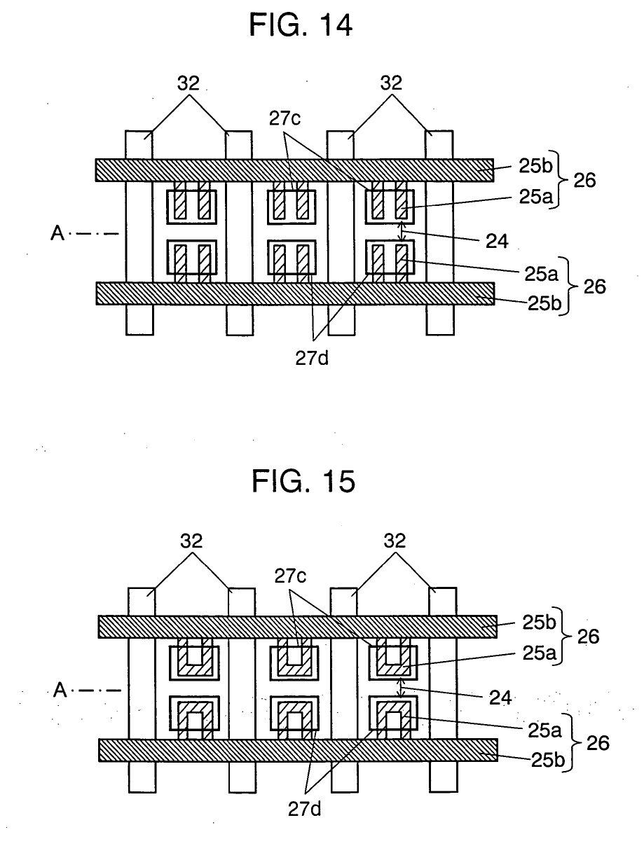

Discharge electrodes 25a in a discharge cell as illustrated in FIG. 14 represent a configuration in which they are divided into a plurarity of parts. Discharge electrodes 25a in a discharge cell shown in FIG. 15 are made hollow by gouging out discharge electrodes 25a as shown in FIG. 12. By decreasing the area of the discharge electrodes in this way, similar advantage as described in Preferred Embodiment-1 in reference to FIG. 4 and FIG. 5 can be obtained.

Here, the shapes of recess 27c and recess 27d are not limited to rectangles as shown in FIG. 12. In so far as the width of recess 27c and recess 27d is greater than the width of the part that faces discharge electrodes 25a with discharge gap 24 interposed, the shape does not matter.

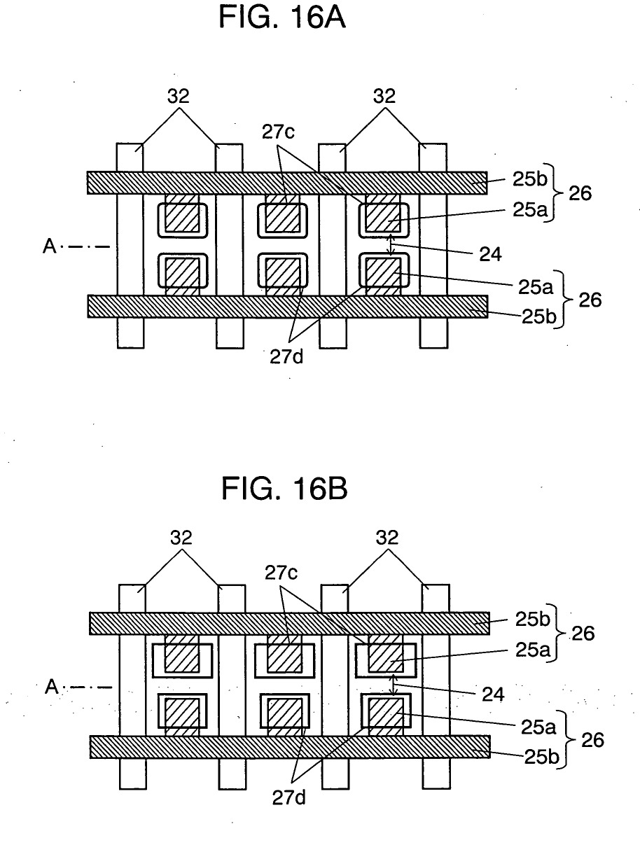

FIG. 16A and FIG. 16B illustrate examples of other shapes of recess 27c and recess 27d. The shape of recess 27c and recess 27d as shown in FIG. 16A is a rectangle with rounded corners. Recess 27c and recess 27d as shown in FIG. 16B differ in size.

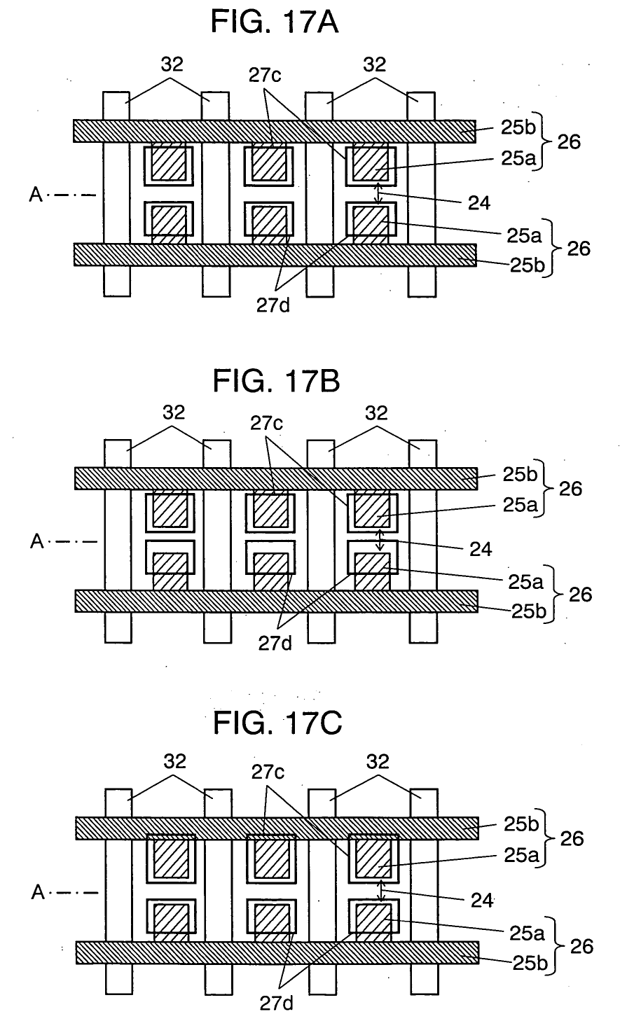

Also, by forming one of recess 27c and recess 27d that oppose display electrode 26 to be used as a scan electrode in a manner such that the opposing area is greater, discharge between the scan electrode and address electrode 30 is made easy to take place during addressing operation. That is, driving margin of the panel can be widened. Examples of such structures are shown in FIG. 17A to FIG. 17C. FIG. 17A illustrates an example of a structure in which the area that recess 27c opposes the scan electrode is made greater by making the size of recess 27c greater than that of recess 27d. Also, FIG. 17B-illustrates an example of a structure in which the overlapping area of recess 27c and discharge electrode 25a is made greater than the overlapping area of recess 27d and discharge electrode 25a by forming them closer to the scan electrode relative to discharge gap 24, although the sizes of recess 27c and recess 27d are the same. Also, FIG. 17C illustrates an example of a structure in which a part of recess 27c is formed on bus electrode 25b of the scan electrode in order to enhance the above-described advantage. Here again, the shapes of recess 27c and recess 27d may be like those illustrated in FIG. 16A and FIG. 16B.

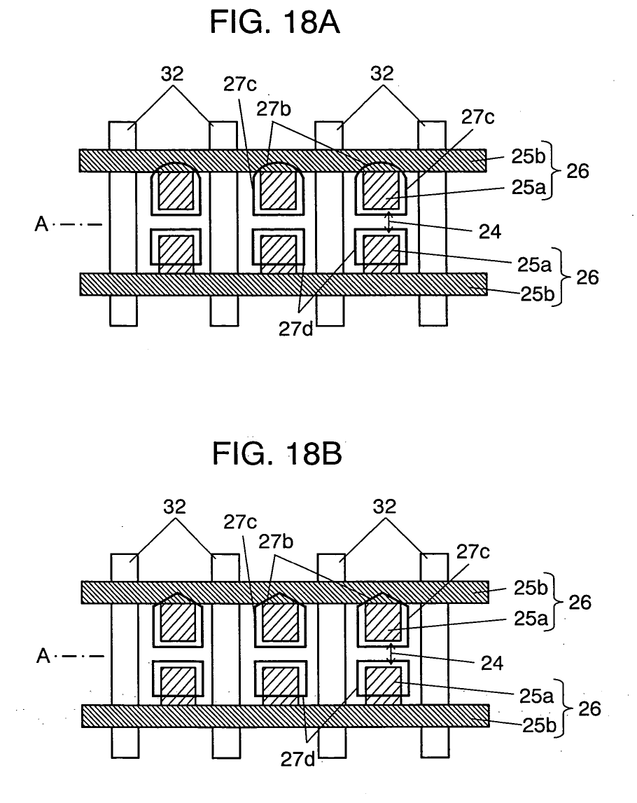

Here, in the case of a structure as shown in FIG. 17C, the thickness of dielectric layer 27 becomes thin because of that part of recess 27c which overlaps bus electrode 25b. For this reason, there is a possibility that the dielectric breakdown strength of dielectric layer 27 of this part is reduced. Therefore, it is preferable to form that part of recess 27c which overlaps bus electrode 25b to a smallest possible size. For this purpose, recess 27c having partly protruding extended recess 27b is formed and the bottom region of partly extended recess 27b is situated on bus electrode 25b. To be more specific, FIG. 18A shows an example of partly extended recess 27b that has a curved protrusion. Also, in FIG. 18B, an example of partly extended recess 27b having a pointed shape is shown.

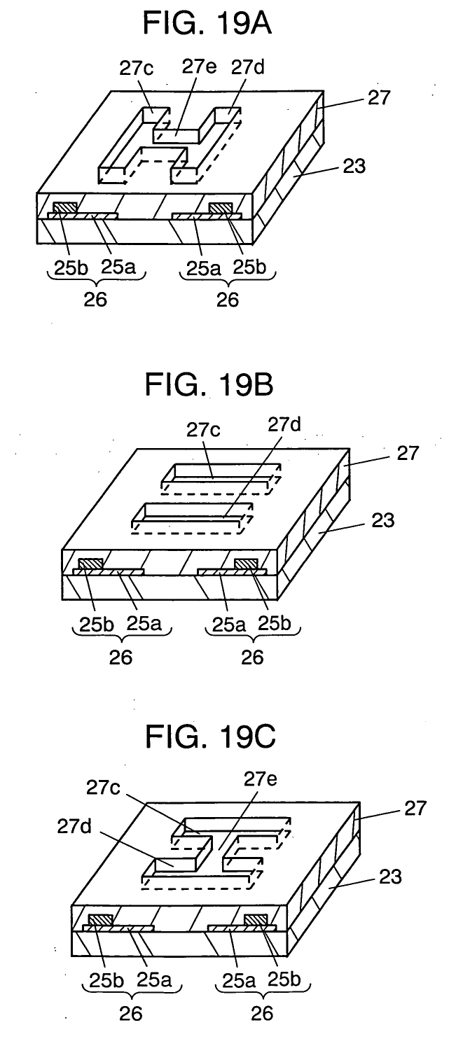

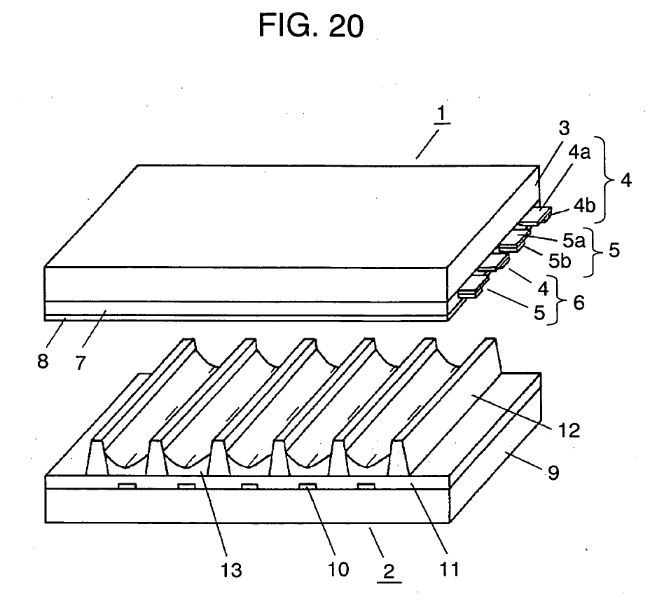

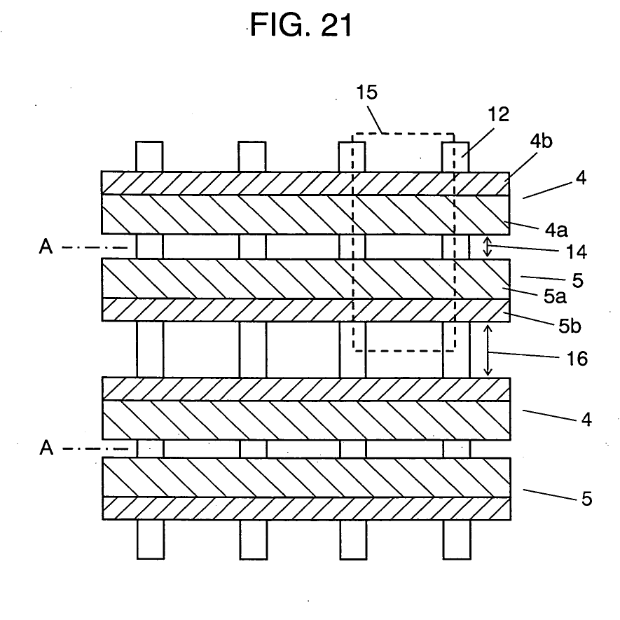

Also, other embodiments of the recess are shown in FIG. 19A to FIG. 19C. In the example shown in FIG. 19A, at least one groove 27e is formed that connects recess 27c and recess 27d for each afore-described discharge cell. In this case, compatibility of a reduction in the discharge starting voltage and an increase in the discharge distance is obtained. In the example shown in FIG. 19B, two recesses 27c, 27d are formed parallel to each other in the direction orthogonal to bus electrodes 25b. In this case, the discharge starting voltage can be reduced. Furthermore, in the example shown in FIG. 19C, at least one groove 27e is formed that connects recess 27c and recess 27d shown in FIG. 19B.

In the above, although a description was made on an example of forming two recesses 27c, 27d, more than two recesses may be made and the shape of the recesses may be polygonal, circular, or oval. In so far as the above object can be achieved, the shape of the recess is not limited to what is described above.

### INDUSTRIAL APPLICABILITY

With the plasma display device in accordance with the present invention, discharge can be controlled while the driving during the addressing period can be stabilized. Also, the efficiency improvement due to a high xenon (Xe) partial pressure can be effectively utilized enabling improvements in the panel efficiency and picture quality.

1. A plasma display device comprising:
a pair of a front substrate and a back substrate that are opposingly disposed in a manner such that an discharge space divided by ribs between the substrates is formed;
a pair of display electrodes comprising discharge electrodes that are opposingly disposed on the front substrate for each displaying line with an discharge gap interposed and a bus electrode for supplying power to the discharge electrodes such that an discharge cell is formed between the ribs; and
a dielectric layer formed in a manner covering the display electrodes; wherein
at least one recess is formed on the dielectric layer on the surface on the side of the discharge space of each discharge cell, and the discharge electrodes are formed in a manner projecting out from the bus electrode toward the discharge gap in order that the discharge electrodes oppose each other in the bottom region of the recess with the discharge gap interposed.

2. The plasma display device of claim 1, wherein the width of the discharge electrodes that oppose each other in the bottom region of the recess with the discharge gap interposed is equal to or smaller than the width of the recess.

3. The plasma display device of claim 1, wherein the discharge electrodes that oppose each other in the bottom region of the recess with the discharge gap interposed is divided into plurarity.

4. The plasma display device of claim 1, wherein the discharge electrodes that oppose each other in the bottom region of the recess with the discharge gap interposed is removed.

5. The plasma display device of claim 1, wherein the discharge electrodes are transparent electrodes.

6. The plasma display device of claim 1, wherein an discharge gas to be filled in the discharge space is a mixed gas containing xenon (Xe) and at least one of neon (Ne) and helium (He), and the partial pressure of Xe is in the range 5 to 30%.

7. The plasma display device of claim 1, wherein the recess is asymmetrical with respect to the discharge gap.

8. The plasma display device of claim 1, wherein the recess is formed in a manner such that the area of the part situated on one of the display electrodes is greater than the area of the part situated on the other of the display electrodes.

9. The plasma display device of claim 1, wherein the recess is formed closer to one of the display electrodes with respect to the discharge gap.

10. The plasma display device of claim 1, wherein the recess is formed in a manner such that the bottom region of the recess is situated on a bus electrode of one of the display electrodes.

11. The plasma display device of claim 10, wherein the recess is formed in a manner such that an extended recess is formed on a part of the recess and a bottom region of the extended recess is situated on a bus electrode of one of the display electrodes.

12. The plasma display device of claim 1, wherein two recesses are formed in a manner such that a bottom region of one of the recesses is situated on a bus electrode of one of the display electrodes.

13. The plasma display device of claim 12, wherein one of the recesses has an extended recess formed on a part of the recess and a bottom region of the extended recess is situated on a bus electrode of one of the display electrodes.

14. The plasma display device of claim 1, wherein two recesses are formed and the two recesses are connected by at least one groove.
